(19) United States
(12) Patent Application Publication
(10) Pub. No.: US 2022/0407684 A1
(43) Pub. Date: Dec. 22, 2022

(54) SYSTEM AND METHOD FOR GENERATING AND DISTRIBUTING WEB FORM FOR COLLECTING DATA

(71) Applicant: Vermeg Factory, Tunis (TN)

(72) Inventors: Badreddine OUALI, Tunis (TN); Brahim HALMAOUI, Tunis (TN); Majdi NAFTI, Tunis (TN); Khaled MATHLOUTHI, Tunis (TN); Mohamed Amin ABDMOULEH, Tunis (TN); Imed BEN MIMOUN, Tunis (TN)

(21) Appl. No.: 17/839,718

(22) Filed: Jun. 14, 2022

Related U.S. Application Data
(60) Provisional application No. 63/210,181, filed on Jun. 14, 2021.

(51) Int. Cl. H04L 9/08; H04L 9/14; H04L 9/06; G06F 40/186

(52) U.S. Cl. CPC H04L 9/0819; H04L 9/14; H04L 9/0894; H04L 9/0618; G06F 40/186

(57) ABSTRACT

The present disclosure describes method and system for generating and distributing a web form for securely collecting data. The system provides an interactive and visualized tool to add, edit, distribute web form and collect and analyze one or more response to the web form. Users of the system may edit the forms in a way that what you see is what you get. The system also automatically generates the data structure that can be easily transferred to and stored in the database, which only require minimal input from the user in terms of the data structure. The stored web form and the received responses are encrypted so as to be only available to the user. In some aspects, the system manages all the projects and workflow and allows for real time monitoring of this process through dashboard.

### CROSS-REFERENCE TO RELATED APPLICATION

This application claims priority to U.S. Provisional Patent Application Ser. No. 63/210,181, filed Jun. 14, 2021, which is hereby incorporated by reference in its entirety.

### TECHNICAL FIELD

The application relates to the field of information processing and more particularly relates to system and method for interactively generating and distributing a web form for securely collecting data.

### BACKGROUND

Online forms are widely used by many businesses. For example, hotels and restaurants send forms to get feedback from their guests about their experience of their past visits. Many businesses have a membership system that requires their customers to fill out an online form to get their personal information. Insurance companies also require their clients to fill out forms when they buy or change an insurance policy.

Often, these businesses may need to customize the forms for a specific group of customers or some specific individual customers. Usually, it requires the knowledge of webpage design and database to create and edit online forms. Therefore, there are needs for tools that may interactively and visually create and edit online forms to collect data.

Additionally, forms are often returned in paper or scanned image format. Data gathered from the forms are then manually entered into databases. This is an inefficient process and prone to errors.

Furthermore, the process of sending, collecting and using the information captured in these forms is heavily relying on human intervention. There exist needs to automate this process including (1) sending the form in the preferred channel and preferred device of the customer (email, website, SMS, etc. through smartphones, tablets, computers, etc.) (2) monitoring the process through analytics and dashboard and (3) uploading and extracting information without IT or human intervention to send to other parties or IT platforms, according to the present invention, is the key to achieving efficiency and client satisfaction while protecting the collected data from unauthorized access.

### BRIEF DESCRIPTION OF DRAWINGS

The foregoing summary, as well as the following detailed description of the preferred embodiments, will be better understood when read in conjunction with the appended drawings. It should be understood, however, that the invention is not limited to the precise arrangements and instrumentalities shown. In the drawings,

FIG. 1 illustrates an exemplary system for generating and distributing a web form for collecting data according to one embodiment of the invention;

FIG. 2 illustrates an exemplary flow chart of the method for designing and distributing a web form for collecting data according to one embodiment of the invention;

FIG. 3 illustrates an exemplary graphic user interface of dashboard for managing all web forms created by the user according to one embodiment of the invention;

FIG. 4 illustrates an exemplary graphic user interface for designing a web form according to one embodiment of the present invention;

FIG. 5 illustrates an exemplary graphic user interface for designing a web form according to one embodiment of the present invention;

FIG. 6 illustrates an exemplary user interface for designing a web form according to one embodiment of the invention;

FIG. 7 illustrates an exemplary user interface for designing a web form according to one embodiment of the invention;

FIG. 8 illustrates an exemplary user interface for providing and tracking information related to the recipients according to one embodiment of the invention;

FIG. 9 illustrates an exemplary user interface for managing and analyzing the responses from the one or more recipients according to one embodiment of the invention;

FIG. 10 illustrates an exemplary user interface for managing web form projects according to one embodiment of the invention; and

FIG. 11 illustrates an exemplary user interface for managing web form projects according to one embodiment of the invention.

### DETAILED DESCRIPTION

Preferred embodiments will be set forth in detail with reference to the drawings, in which like reference numerals refer to like elements or steps throughout.

System and method for generating and distributing a web form for collecting data is disclosed herein. One embodiment of the present invention provides a graphical interface to a user, allowing the user specify at least one data field and data type of the at least one data field of the web form in an interactive and WYSIWYG (what you see is what you get) way. The web form is then generated and stored. The web form is then made accessible to one or more recipients from whom the data will be collected. Upon the user's choice, a URL (Uniform Resource Locator) to the web form may be sent to the recipients through email or text, or posted on social medium or any online platform that is accessible to the recipients. The URL may be presented in plain text, QR code, or any form that is readable by the recipients' devices. The responses from the recipients filling out the web form will thus be stored and may be further analyzed. The respective responses are associated to the corresponding responses, respectively, by, for example, creating a token or unique id when the recipient visit the URL. The web form and the responses are encrypted so that they are only available to the user. The system and method for generating and distributing a web form for collecting data may thus provide a streamlined interface for the user to design a web form in a way that what you see is what you get. The web form may be published to the target recipient through various channels such as email, SMS, and social medium. The responses to the web form may be collected and analyzed automatically with minimal interfere from human. The responses may also be shared easily to a user's local device or online platforms.

Below, the embodiments of the system and method for generating and distributing a web form for collecting data will be described by referring to the drawings.

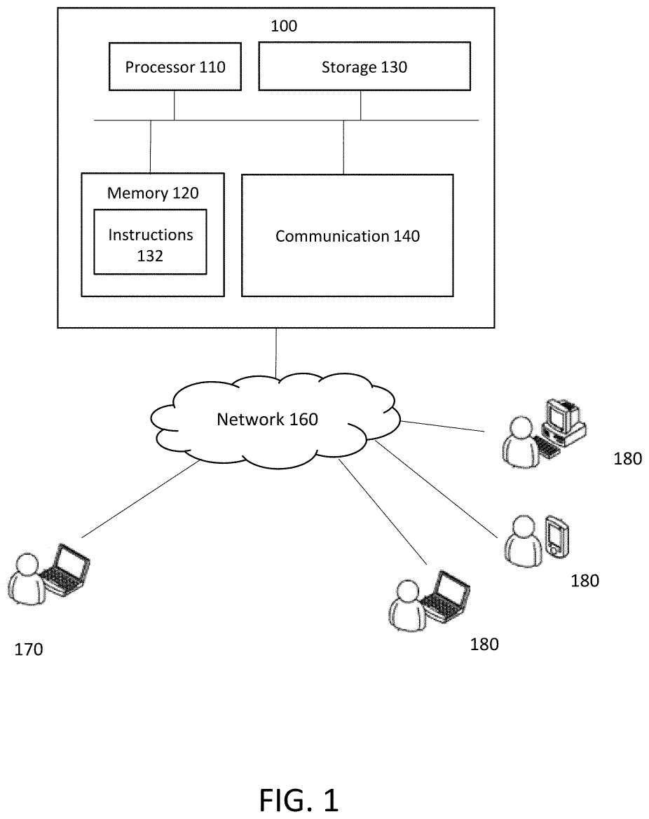

FIG. 1 illustrates an exemplary system 100 for generating and distributing a web form for collecting data according to one embodiment of the invention. The system 100 includes a computing system 100 having at least one processor 110, memory 120 coupled to the at least one processor 110, storage 130, and communication device 140. The memory 120 comprises computer executable instructions that are executable by the at least one processor 110 so that the system 100 may perform the method according to the embodiments of the present invention. The communication device 140 connects the system 100 to the network 160. The storage 130 may be used to store data including user's credential, user's web forms, and recipients' responses. Alternatively, the storage 130 may also comprise a database server or a cloud data platform coupled to the system through the network. The storage according to the present invention should be interpreted to include either embodiments.

The memory 120 includes computer storage media in the form of volatile and/or nonvolatile memory such as ROM and RAM.

The network 160 illustrated in FIG. 1 includes a local area network (LAN) and a wide area network (WAN) but may also include other networks. Such networking environments are commonplace in offices, enterprise-wide computer networks, intranets, and the Internet. When used in a LAN networking environment, the computing system 100 is connected to the network 160 through the communication device 160, which may be a network interface or adapter. When used in a WAN networking environment, the computing system 100 typically includes means for establishing communications over the network, such as the Internet.

In this embodiment the storage 130 is coupled to the at least one processor 110. By way of example only, the storage 130 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM or other optical medium. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive is typically connected to the system bus through a non-removable memory interface, and magnetic disk drive and optical disk drive are typically connected to the system bus by a removable memory interface, such as interface 150.

In another embodiment, the storage 130 may be at least one database server that is connected to the computing system 100 through network 160.

The computing system 100 in the network environment may also be embodied as a cloud computing system. Specifically, cloud computing is the on-demand availability of computer system resources, especially data storage (cloud storage) and computing power, without direct active management by the user. Commercially available examples of cloud computing service include Amazon Web Services (AWS) and Microsoft Azure, among others.

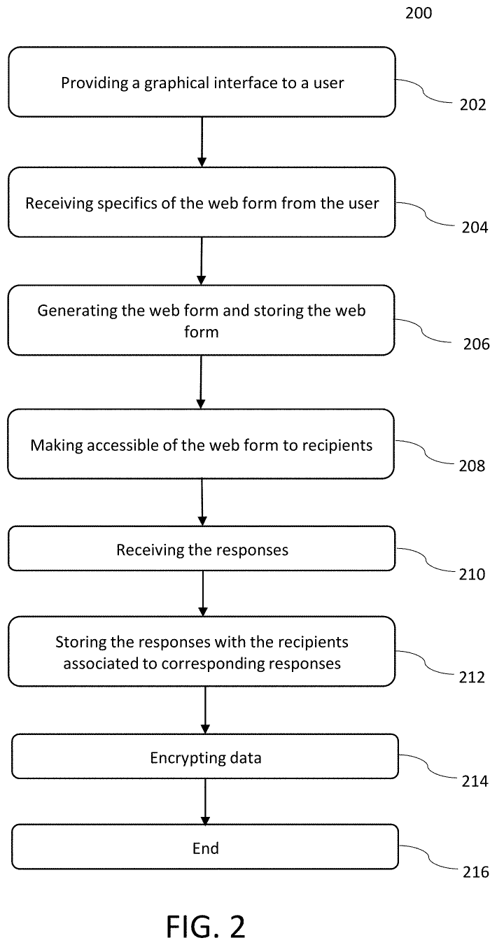

FIG. 2 illustrates an exemplary flow chart of the method 200 for designing and distributing a web form for collecting data according to one embodiment of the present invention.

As shown in FIG. 2, the method 200 starts at the step 202, providing a graphical interface to a user. This can be achieved by providing a website that may be accessible through a WAN or Internet or an application that may be run on a computer or a mobile device. At step 204, the method 202 receives the specifics of the web form designed by the user. The graphical interface will allow the user to design a web form with at least one data filed. An element library may be provided to the user so that the user may choose data field and data type, which comprises at least one of single input, multiple input, check box, radio group choice, dropdown, rating, ranking, image, Boolean, signature pad, file uploader. In addition, the graphic interface may also allow the user to set logic conditions among the data fields, for example, to decide if an element is visible, or required, or editable. For example, if a recipient checks a specific box in one question, one or more follow up questions will become visible; otherwise they will not show up.

In one embodiment, the method may provide a preset template for the user to start with. For example, the method may provide the user with a basic personal information form, a standard insurance claim form, among others. In another embodiment, the method may also allow the user to save the web form as a template for later user.

The graphic interface will be described later in detail.

Once the user has finished web form designing, the method 200 goes to the step 206 to generate the web form and store the web form. In one embodiment, the web form is generated as a webpage.

The method 200 then goes to the step 208 and makes the web form accessible to one or more recipients. In one embodiment, the method 208 may ask the user to provide contact information of the recipients who are supposed to fill out the web form, such as phone number or email address. Therefore, the method 200 will send the URL to the web form to the recipients via email or text. In another embodiment, the method 208 may also allow the user to provide authorization to post the URL to a social medium, such as, Twitter, LinkedIn, Instagram, Snapchat, Facebook, or other online platform. The user may control the accessibility of the post on the corresponding platform. The URL may be presented in a plain text or QR code.

The method 200 then goes to the step 210, receiving the responses from the recipients and the step 212, storing the responses. In one embodiment, the method 200 only receives and stores a response when the user finishes all the questions and submits the response. In another embodiment, the method 200 receives and stores the response or updates the stored response every time a recipient changes the any part of the response until the response is completed and submitted. In one embodiment, the responses may be stored in a storage 130 that is directly coupled in the system 100. In another embodiment, the response may be stored on a database server that is connected to the system 100 through the network 160. In another embodiment, the method 200 may require the user to provide authorization to access the user's cloud platform, such as Google Sheet, Google Drive, Slack, Zapler, and automatically share the response with these cloud platforms. In another embodiment, the user is provided the option to export the data to the user's local device or cloud platform.

At the step 214, the method 200 has the user's data including at least the web form and the received responses encrypted so that the user's data is only accessible to the user. The encryption will be described later in detail. The encryption may be executed every time any piece of user's data is stored, for example, when the web form is stored or when a response is received. The method 200 will then ends at the step 216.

Web Form Designer

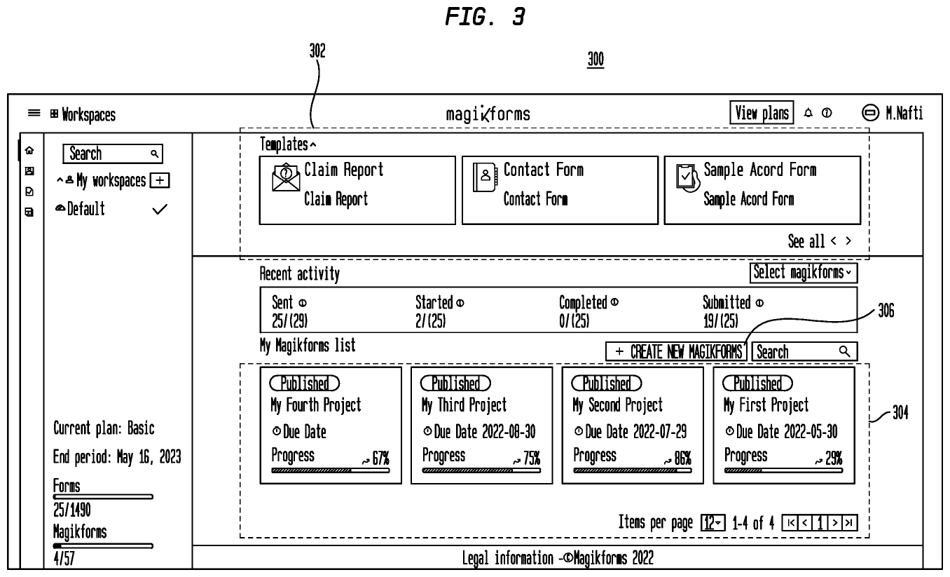

Below, the graphic interface for the user to design the web form according to one embodiment of the invention is described by referring to FIGS. 3-7.

FIG. 3 illustrates an exemplary graphic user interface 300 of dashboard for managing all web forms created by the user. As shown in FIG. 3, the graphic user interface 300 comprises an area 302 providing form templates 312 and an area 304 providing a list of existing web forms 314 with their status. For example, the form templates 312 include a contact form template, an insurance claim report template, and a sample accord form. When the user choose to create a new web form by clicking the button 306, the user will be prompted to create a new web form from any one of the templates or a blank new one. If the user choose to create the new web form a template, the new web form will then contain the data fields that have been preset in the corresponding template. For example, the contact form may contain single input data fields for filling in first and last names, a multiple input for filling in address, a dropdown for selecting resident state, among others.

In the area 304, existing web forms created by the same user are listed. The status of each web form may also be provided, which may, for example, the expiration date of web form, and the progress of the web form (rate of the collected responses to expected responses).

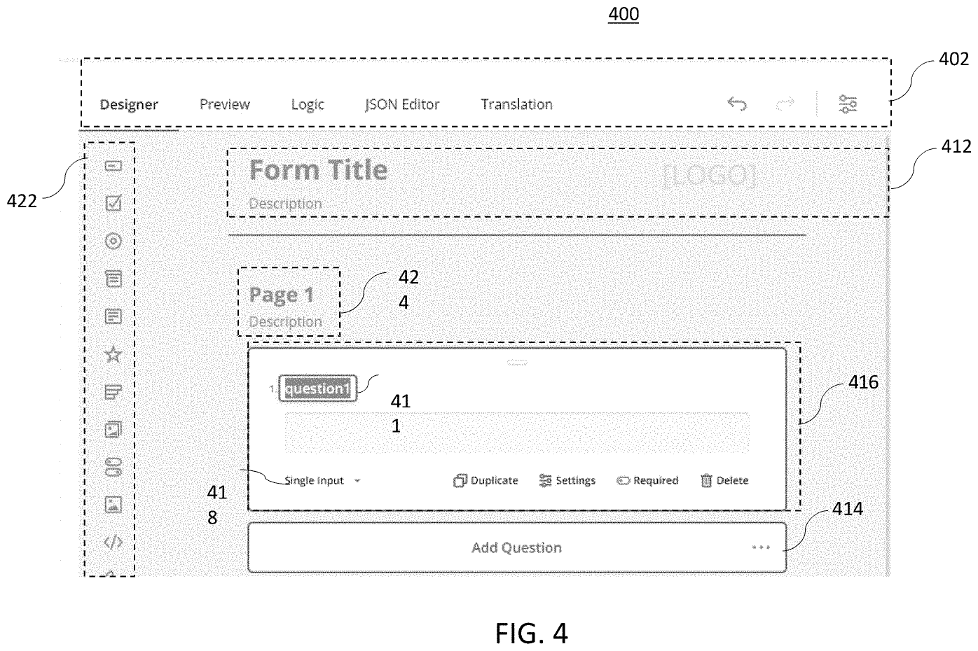

FIG. 4 illustrates an exemplary graphic user interface 400 for designing a web form according to one embodiment of the present invention. When a user of the system 100 chooses to start a new project and generate a new form from the dashboard, the system will provide the user a graphic interface as shown in FIG. 4.

As shown in FIG. 4, the system 100 provides an interactive and visualized workplace for the user to design and edit the form. The graphic interface 400 includes functional tabs in the area 402 from which the user may switch among designing the web form, adding logic conditions to the web form, code editing the web form (JSON, for example), and previewing the web form. an input box 102 for inputting the name of the form, a work area 104 to edit the form, and a toolkit area 106 in which the tools for adding and editing the questions in the form.

Below the area 402 is the form designing workplace. As shown in FIG. 4, by clicking the corresponding section, the user may edit corresponding elements of the form. For example, the user may, at the section 412, edit the title and description, and add or edit logo by inserting an image.

The user may add a question by clicking the button 414. In FIG. 4, an exemplary editing section 416 for a first question is shown. Each question is a data field and the user may define the type of the data field by selecting at the dropdown 418. In this example, the data type of the first question is a single input. The user may also edit the question of the data field at the section 411. For example, if the first question is a date field of single input asking for the recipient's first name, the user may input “First Name” in the section 411.

The system 100 may provide an element library for user to choose, which may comprise at least one of single input, multiple input, check box, radio group choice, dropdown, rating, ranking, image, Boolean, signature pad, and file uploader. Single input allows a recipient to input one line of text; multiple input is allows a recipient to input more than one line of text; check box is a small box into which a check or other mark may be entered as the response to the question; radio group choice is a set of radios that allow a recipient to select exactly one option in the set; dropdown lists all the options when being clicked and allows a recipient to choose one option from the list; rating allows a recipient to provide a rating on the question that may be presented in various ways, for example, five or other number of stars (or other symbols) that allows a user to select any number of the stars indicating a rating, or an input value from a predetermined range (for example, 1-10) indicating the rating; Boolean is a question that requires an answer of Yes or No; image allows a recipient to upload an image; signature pad allows a recipient to sign; and file uploader allows a recipient to upload a file locally from the recipient's device.

In addition, a toolkit section 422 may be optionally provided. The user may, by selecting an icon in the section 422, add a question or data field with a data type corresponding to the selected icon.

As shown by the section 424, the graphic interface 400 allows the user to arrange the data fields or questions across more than one pages and allows the user to add and edit description of each page.

In addition, the graphic interface 400 may allow the user to set a logic rule to change the web form in response to a recipient's input to a data field. For example, a logic condition may show or hide one or more data fields, enable or disable one or more data fields, make a data filed required, set an answer of or copy an answer to one or more data fields, complete or submit the web form, among others, when an input of a data filed (that is, an answer) from the recipient meet a predetermined condition, such as, the answer equals to, greater than, or smaller than a predetermined value; contains or does not contain a predetermined value or character; and so on.

In addition, the graphic interface 400 may allow the user to set validation of data field that is being filled by a recipient. The graphic interface 400 allow the user to set the data validator as, for example, number, text, email, regular expression, and so on. The graphic interface 400 may further allow the user to set maximum or minimum value of a number, maximum, minimum, or exact length or digit of a number, maximum, minimum, or exact length of a text, and so on. If an input from a recipient does not meet the validator, an error message may be prompted, which may also be editable by the user.

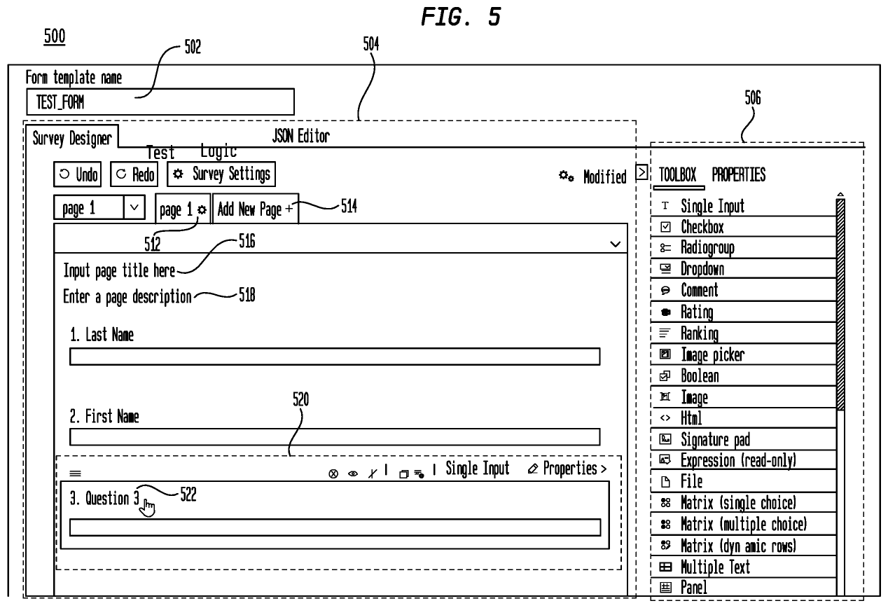

FIG. 5 illustrates an exemplary graphic user interface for designing a web form of the system 100 according to another embodiment of the present invention. When a user of the system 100 chooses to start a new project and generate a new form, the system will provide the user interface as shown in FIG. 5.

As shown in FIG. 5, the system 100 provides an interactive and visualized workplace for the user to generate and edit the form. The user interface 500 according to this embodiment includes an input box 502 for inputting the name of the form, a work area 504 to edit the form, and a toolkit area 506 in which the tools for adding and editing the questions in the form.

In the input box 502, the user may input a name for the form. The customers who will fill out the form will not see the name. it is for the ease of the user to manage and categorize the forms, especially when the user may generate and manage a plurality of forms.

The work area 504 provides an editor of a form in a way that what you see is what you get. Some forms may request data from the customers in more than one pages. Therefore, the work area 504 provides tab 512 each corresponding to one of the pages. The user may also click on tab 514 to add a new page.

On the top of each page, the user may edit the title 516 and description 518, which will be present in the corresponding page. Below the description 518, the user may add and edit questions in the form. In the toolkit area 506, all available tools each corresponding to a possible element in the form is listed. For example, the first tool in the toolkit area 506 is single input, which will allow the customer to type in an answer for the corresponding question, for example, first name, last name, comments, text answer, and so on. The user may simply click and hold the tool “single input,” and drag it to the blank area in the page, a corresponding editor 520 will show up. In the example shown in FIG. 5, the user has added two questions which are both single input and ask for input of last name and first name. When the user drags the “single input” tool to the position below the second question, the editor 520 shows up and generate the number “3” automatically. The user may edit the description of the question at the box 522. Since this is a single input question, an input box is shown below the question.

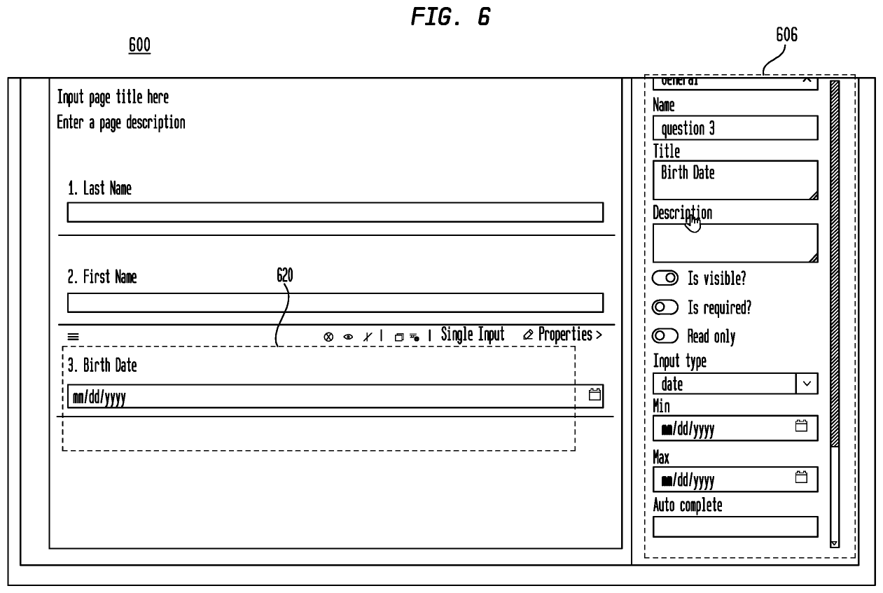

As shown in FIG. 6, the user interface 500 will then provide corresponding settings of the newly added data field 620, that is, a question. In this example, the settings are shown in the area 606. However, the setting may also be shown in other ways, such as, a prompt window. As shown in the area 606, the settings include the content of the question and its data structure. The name defines the name for the data entry that will be recognized and stored by the database. The title is the title of the question, in this example, the birth date. The user may also add description to add explanation and instructions about the question. The user may also choose the input type of this question. In this example, the input type is date, therefore, the format is chosen as “mm/dd/yyyy,” the customers will only be allowed to input in the specified format. The user may also set minimal and maximum value of the date. In addition, the user may also set the question as “required,” which means that the customers will have to answer this question before going to next page or submitting the form. When the form is filled and submitted by a customer, the name, data type, input from the customer will be transferred to the database server in JSON format, which is a text-based format to describe data structure and will be further discussed later. In other embodiment, these data may also be transferred in other data structure, such as XML, HTML, among others.

As shown in FIG. 5, there are many other question tools that are listed in the toolkit area 506, including but not limited to checkbox, dropdown box, radiogroup choice, multiple choice, rating, Boolean question (a yes-or-no question), multiple text, image upload, attachment uploader, and signature pad. By dragging corresponding question tool into the corresponding page, the user may add the question to the form and then edit the question and its data type through the settings just as the aforementioned example of the single input. The signature pad may provide a panel for a customer to sign with a mouse or electronic pen. Additionally, or alternatively, the signature pad may also connect to a third-party electronic signature service, such as, DocuSign.

The user may also drag the questions to adjust their order in the form. When adding a new question, the user may also insert the tool between two questions to position the new question in the form.

In other embodiments, some questions that are often used in forms can also be additionally preset and listed in the toolkit, such as, first names, last name, birthday, age, gender, etc. In some embodiments, the user may be allowed to customize a preset questions in the toolkit.

Additionally, or alternatively, the user may also add a question by clicking on, double clicking on, hovering the mouse, or otherwise taking an interactive action on the corresponding tool.

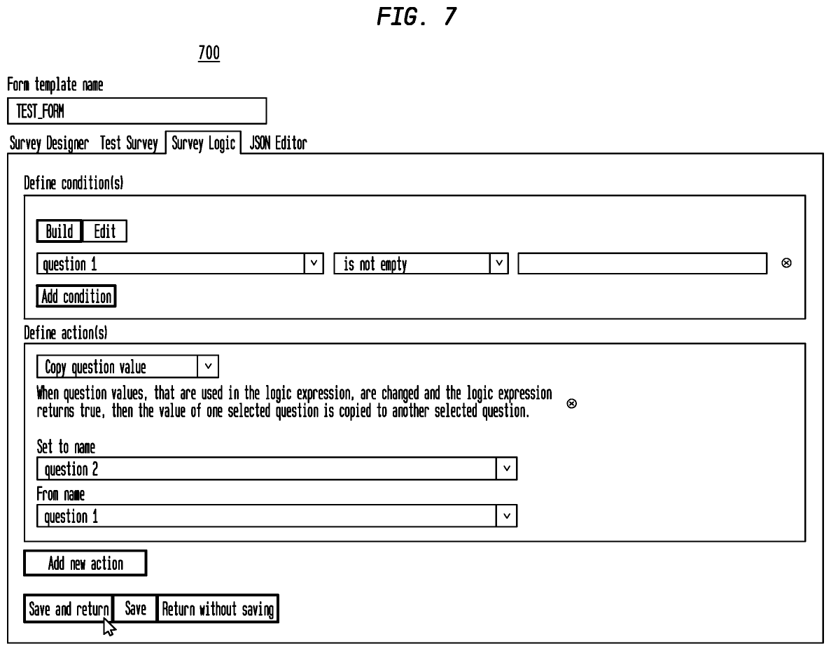

As shown in FIG. 5, in the work 504, there is a tab “Logic,” which provides the user with the settings to customize actions based on the input of a customer on the questions. FIG. 7 illustrate an example user interface 700. As shown in FIG. 7, the user may set one or more conditions and one or more actions when the preset one or more conditions are met. In the example shown in FIG. 7, the user set to copy question value of “question1” to “question2” when the value of “question1” is not empty, meaning the customer has answered the question with the name “question1”. Herein, “question1” and “question2” are the names of corresponding questions that can be edited by the user and will be read as the data entry name by the database. This may provide a user-friendly form to the customers when the form requires the customer to answer the same question for multiple times. For example, the form may ask for a customer's name in multiple questions. The form may ask for a customer's signature at multiple places. The user interface 100 may offer other optional conditions, such as when the answer equals to, greater than, lower than, a specific value; when the answer is or is not a character string containing predetermined characters; among others. When setting a plurality of conditions, the user is also allowed to connect these conditions with logic operators such as “AND” and “OR.” Example of actions may include copying question value, prompting to reinput an answer, enabling/disabling follow-up questions, skipping a question, showing a message (for example, a thank you note), submitting the form, among the others.

In the one embodiment, the elements in the form will be translated into JSON data structure. JSON (JavaScript Object Notation) is a lightweight data-interchange format. It is easy for humans to read and write. It is easy for machines to parse and generate. It is based on a subset of the JavaScript Programming Language Standard ECMA-262 3rd Edition—December 1999. JSON is a text format that is completely language independent but uses conventions that are familiar to programmers of the C-family of languages, including C, C++, C#, Java, JavaScript, Perl, Python, and many others. These properties make JSON an ideal data-interchange language. JSON is built on two structures: A collection of name/value pairs. In various languages, this is realized as an object, record, struct, dictionary, hash table, keyed list, or associative array. An ordered list of values. In most languages, this is realized as an array, vector, list, or sequence. The standard of JSON can be found at www.json.org.

Below is an example of JSON data structure when there is one page with two questions in the form. In this example, the first question asks for the full name and return a text with a name “fullname” in the data entry. The first question will show up in the form as defined by its title “1. Full Name” in the form. Similarly, the second question asks for a choice of programs and return a checkbox with the name “selected program” in the data entry.

```
{
  “pages”: [
    {
      “name”: “page1”,
      “elements”: [
        {
          “type”: “text”,
          “name”: “fullname”,
          “title”: “1. Full Name”
        },
        {
          “type”: “checkbox”,
          “name”: “selectedprogram”,
          “title”: “2. Select Programs”,
          “choices”: [
            “program 1”,
            “program 2”,
            “program 3”
          ]
        },
      ]
    }
  ]
}
```

As shown in FIG. 5, the work area 504 includes a tab “JSON Editor,” which allows the user to edit directly the JSON data structure of the form, if the user is familiar with JSON.

It can be understood that alternative data structures for transferring data online can be used, such as, XML, HTML, YAML, Protubuf, Avro, MongoDB, OData, among others.

As shown in FIG. 5, in the work 104, there is a tab “Test.” The user may test the form to check if it runs or return a data structure as expected, even when the user has only added a part of the questions. It provides a user-friendly interface for the user to test and debug the form.

Web Form Publishing

After the user has completed the design of the web form, the system 100 may then store the web form, and generate the web form as a webpage. The system 100 also provides function of publishing the web form, that is, making the web form accessible to one or more target recipients.

In one embodiment, the system 100 requires the user to provide contact information of the recipients, such as mobile number or email address. The system 100 may then send the URL of the web form to each of the target recipients. As aforementioned, the URL may be presented as a plain text or QR code. For example, the user may input the contact information, or upload a file containing the recipient data. In another embodiment, the system 100 may also obtain the user's authorization to directly connected to the user's database server, which contains the information of the user's customers to obtain contact information of the target recipients. The system 100 will then send an email or SMS with the URL to the web form. The system also allows the user to add, edit, or remove recipients. In addition, the system may allow the user to export the recipient list in a spreadsheet or add recipients by uploading a spreadsheet with predetermined format. For example, if the user is an insurance company, its recipients, that is, its customers may include an entity with employees. The entity information can be set as the group information, and its employees can be added as the member of the group.

In another embodiment, the system 100 may also obtain the user's authorization to post the URL on the user's social medium or other online platform.

Response Receipt and Analysis

When a recipient opens the web form through the URL, the system 100 will associate the recipient with the corresponding response. In one embodiment, it is achieved by allocate a unique ID or token to the recipient and associate the unique ID or token with the received response.

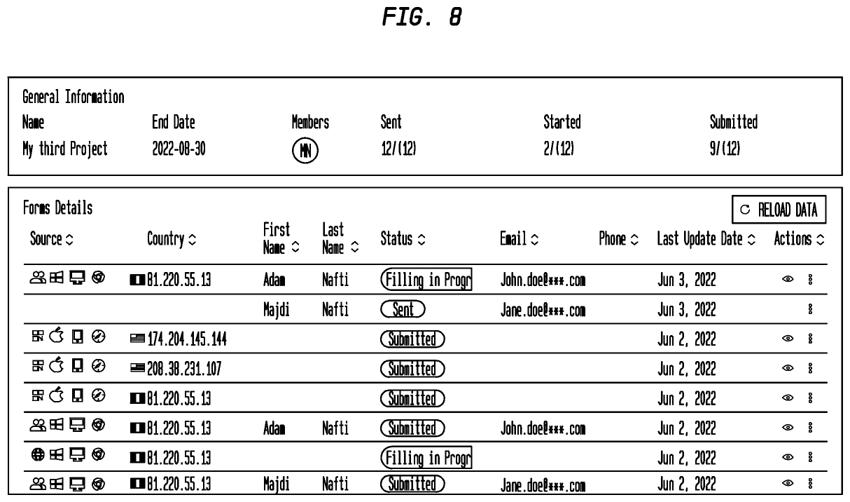

In addition, they system 100 may further record other information related to each of the recipients, such as, the IP address, operating system, navigation application, last update time, and progress status of the web form and provide the information to the user. FIG. 8 illustrate an exemplary user interface 800 providing the user with the information related to the recipient. As shown in FIG. 8, the IP address, operating system, navigation application, last update time are obtained when the recipient visited the URL and are provided to the user. The recipients are associated with their responses respectively, and the status of the responses are also provided, which may include web form sent to the recipient, web form filling in progress, and web form submitted.

The system 100 may then provide analysis based on the status of all the responses. For example, the system 100 may provide the respective ratios of the completed responses and in-progress responses to the overall expected responses. The system 100 may also provide statistic data based on the geographic information, operating system and navigation application of the recipients.

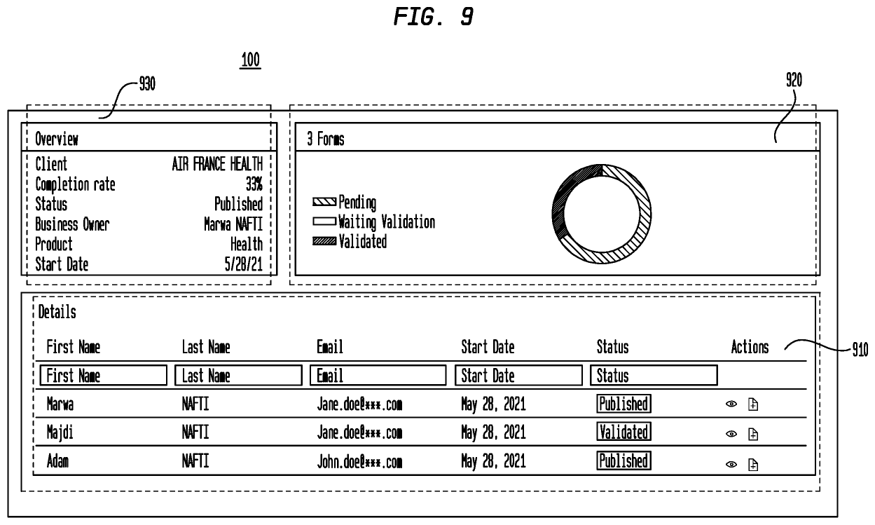

FIG. 9 illustrates an exemplary user interface 900 for the user to manage and analyze the responses from the one or more recipients. As shown in FIG. 9, the system 100 provides a tool to manage web form projects. In the area 910, all the recipients that have been sent the web form or have visited the URL to the web form are listed. The status of the response from each recipient is also shown. For example, the status indicates if the form has been made accessible to the individual, if the individual has submitted the form, if the form has been validated by the user. The user may choose to see the answers an individual has submitted, and if it looks good, may validate the answers, or otherwise request the individual to resubmit answers.

In the area 920, a statistical data of the web form project is shown. It visually provides the user with status of the web form project. The user may know the percentages of the forms that have been published, pending to be submitted, submitted, and waiting for the user to validate. The statistical data may be shown in raw data, histogram, pie chart, among others.

In the area 930, the information about the group of the individual customers. The example shown in FIG. 9 is a web form for collecting information of customers of an insurance provider, the group information includes the entity name, business name, the insurance product, and start date. Some interested status of the form, for example, the completion rate of the form is also shown. This area may be customized based on the nature of the form, and the nature of the customer group and its members.

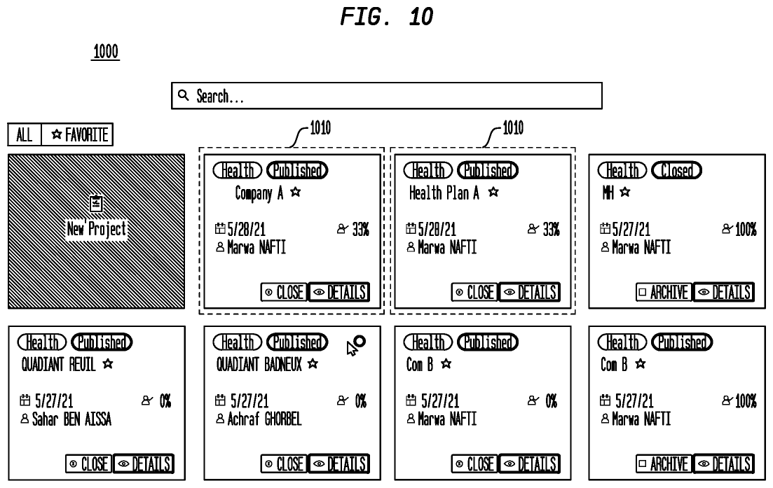

FIG. 10 illustrates an exemplary user interface 1000 of the system 100 for the user to manage all the web form projects according to another embodiment. The existing projects are shown in block areas 1010. The bloc areas 1010 indicates the basic information of the projects, such as the name, start date, contact, and completion rate of the projects. If the user clicks on the details of the projects, the user will be able to see the details of the project, including the web form, the target recipients, and status of the project as shown in FIG. 4. The user will also be able to edit the form and manage the list of the individual customers related to the project. The user may also start a new project through this user interface.

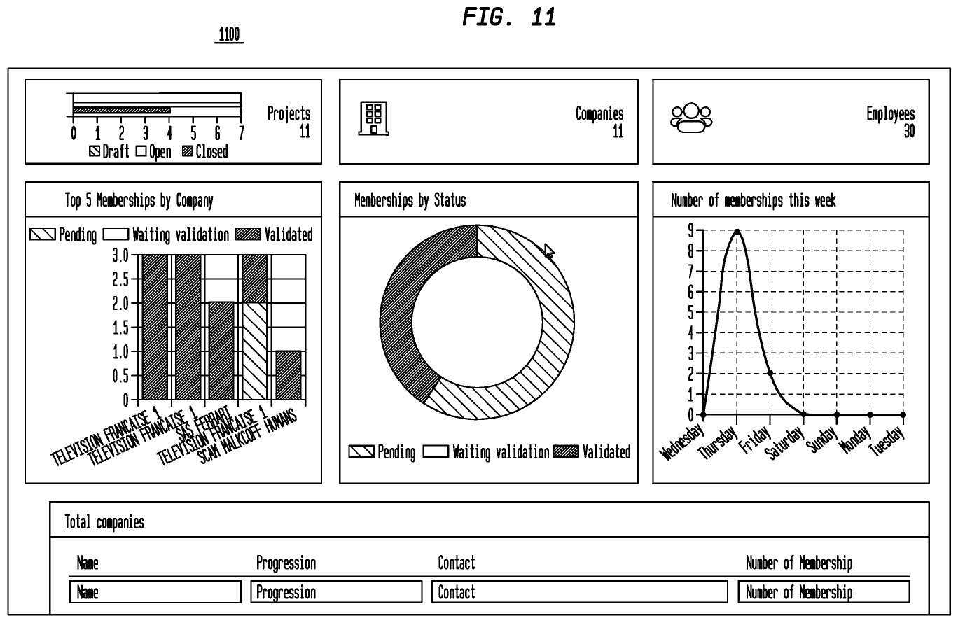

As shown in FIG. 11, the system 100 may further provide a user interface 1100, which synthetically shows the status of all the projects. It may also provide graphs showing the change of the complete forms over time, and status of various projects to indicate the percentage or numbers of forms pending to be submitted, forms that have been submitted and waiting for validation, and forms that have been validated. For example, the dashboard may show the numbers of the projects that are categorized based on their status: draft (the user is editing the project and has not published the form), close (the project has successfully completed or expired if there is an expiration date set for the project), and open (the project has had the forms published and are waiting for the customers to fill out and submit the forms). The dashboard may also show the company or group clients which in turn comprises a group of individual customers.

In addition, the system 100 may also provide the function to export the responses of web form into a document or database on the user's device, such as spreadsheet, a text document (such as PDF or Word), or into a document or database on an online platform such as Google Sheet, Google Drive, Microsoft Teams, Zapier, and Slack, making it easier for the user to access, transfer, and analyze the result.

The system 100 may further provide statistical analysis of the data fields, that is, the questions of the received responses to the web form. For example, for a specific data field, the system 100 may provide the ratio of answers to, for example, a radio group question.

Data Encryption

As described by referring FIG. 2, the system 100 also encrypts at least the stored web form and the received responses so that they are only available to the user. Specifically, to protect the user's data from unauthorized access, the user's data must be securely encrypted in the database; the data is scoped to the user's account, meaning each user has their own set of data linked to their user ID; the recipients can access the web form via the URL and provide response, meaning that any recipient with the URL may write into the database.

In order to achieve these purposes, an asymmetric cryptography is employed. A pair of a public key, which may be known to the others, and a private key, which may not be known by anyone except the owner. The generation of such key pairs depends on cryptographic algorithms that a message encrypted using the public key can only be decrypted with the private key.

To further explain the examples, the notations are provided as follows. For example, if P(x) is the private key for x and Q(x) is the matching public key, e=E(d, Q(x)) means e is the result of encrypting plaintext d with the public key Q(x), and d=D(e, P(x)) means d is the result of decrypting the ciphertext e with the private key P(x). In our case, x can be “User,” “System,” and “Recipient.”

### Example 1

In example 1, the system 100 generate a random key to symmetrically encrypt the user's data which can be decrypted by the same random key. The system 100 then use the user's login password to symmetrically encrypt the random key. The system 100 stores the user's password as a one-way hash, which is a fixed-length binary value calculated from the user's password based on a cryptographic algorithm. This transformation is one-way, that is, given a hash value it is statistically infeasible to reproduce this value.

In order for a recipient to submit a response, that is, to write into the user's database, the system 100 perform an authorization from the user through protocol that is compatible with the corresponding database either on the system 100 or on the cloud platform the user chooses (such as Google Sheet), for example, OAuth 2.0. OAuth 2.0 is the industry-standard protocol for authorization that provides specific authorization flows for web applications, desktop applications, mobile phones, and other smart devices. Under OAuth 2.0, the system 100 generate a token for accessibility of the database in the system 100 or requests a token from a cloud platform with the account credential provided by the user. The token is an encrypted information that can be used as a key instead of login credentials to access the database. The token may be set to expire based on the expiration date of the web form set by the user.

When the user retrieves the user's date from the system 100, the user provides the password to the system 100, the system 100 calculate the hash value of the password and compares the hash value with the stored hash value. If they match, the system 100 encrypted the secret key with the password and then encrypted the user's date with the secret key, and sends the user's date to the user.

In this case, the transmission of the password and the user's data between the system 100 and the user is also encrypted with the aforementioned asymmetric encryption. Specifically, the system has a pair of private key P(System) and a matching public key Q(System). The user's web browser or client application creates a temporary session key, encrypts it with the server's public key Q(server) and sends the encrypted key to the server. The system 100 uses it private key P(server) to decrypt the session key. The system and the user use the session key to encrypt all further communications.

This example may protect the user's data from unauthorized access. In addition, since the user's password is presented as a hash value on the system, even an administrator or hacker that gained access of the server would not be able to decrypt the user's data without knowing the user's password. In addition, it does not require a client application on the user's device, a web browser would suffice. However, since the decryption is performed on the server, there is still a chance that the user's data might be accessible by a hacker when the data is being decrypted.

### Example 2

Example 2 provides a higher level of data protection, in which the decryption of the user's data will be performed on the user's device only.

In this example, the user has a pair of private key P(user) and public key Q(user), the system 100 encrypts the user's data including the web form and the received responses with the public key Q(user) and transmits the data encrypted with the public key Q(user) between the user and the system 100.

Since the user's private key is held on the user's device and will and should never be shared to the system or unauthorized party, the data security is further improved. However, in this case, once an information is encrypted with Q(user), the system 100 will not be able to decrypt it and read it. Therefore, when a recipient is making or changing their response to the web form, the response in progress has to be readable by the system 100 until the response is finalized and submitted. Therefore, the response in progress will either be stored in plain text or encrypted with system 100's own public key Q(system). Thus, the response in progress would be know to the administrator of the system 100 or a hacker who has gained access of the system 100. In order to protect the responses in progress, example 3 may be performed.

### Example 3

In example 3, both the user and each recipient have their own key pairs. P(user), Q(user) is the user's key pair; and P(recipient), Q(recipient) is the recipient's key pair.

The system 100 has a registry of keys where users and recipients can share their public keys. All users and recipients are expected to keep the private key a secret for themselves. To store the user's data on the storage of the system securely, the user's data is encrypted with the public data key: ciphertext=E(plaintext, Q(user)). Therefore, the ciphertext can only be decrypted with the private key P(user).

The user wants to allow the recipient to be able to write the user's data but the system 100 is not able to read either recipient or user's data. In addition, the system 100 is not able to read the recipient's data that will eventually be submitted as the user's data. To be able to do so, the user's public data key Q(user) is encrypted using the recipient's public key Q(recipient) as the recipient write key: Recipient_write_key=E(Q(user), Q(recipient)), and the recipient write key is sent to the recipient.

When the recipient makes changes to the response in progress and submits the changes to the system 100, New_plaintext=changes. The recipient decrypts the Recipient_write_key to obtain the public key of the user: Q(user)=D(recipient_write_key, P(recipient)), and encrypts the New_plaintext: New_ciphertext=E(new_plaintext, Q(user)) and submits to the system 100.

Likewise, to improve the security of transmitting data between the system and the user or recipient, the transmission may be additionally encrypted using the system's public key.

In order to further improve security to be able to revoke the authority of the recipient to add or change response, the user may be allowed to provide a temporary key pair P(data) and Q(data) as a substitute of permanent key pair P(user) and Q(user) to obtain the recipient's response. Once the user obtain the plain text data on their device, the user may encrypts the plain text with the permanent public key Q(user) and keep a copy encrypted with Q(user) on the system and delete the copy encrypted with Q(data) so that the authorization of the recipient is revoked. In the next project, the process will start by the user providing a temporary key pair P′(data) and Q′(data) and repeat the remaining steps.

In this case, the system 100 will not be able to read the response or any changes to the response made by the recipient. However, all the decryption is performed at the user's device, therefore, it requires a dedicated client application with decryption or an add-on to the user's web browser to do so. In addition, it also requires the recipient to maintain an account on the system 100 to associate the recipient's public key with the recipient.

### Example 4

Example 4 provides another solution in which each user stores their respective user master key on a dedicated key server, such as a cloud server including but not limited to a private key server, AWS Key Management Service (AWS KMS) and Microsoft Azure Key Vault, among others. In addition, the key server may also generate a master key for the user. When the system 100 is going to store the user's data, the system 100 will request a data key from the key server. The key server will generate a plaintext data key and encrypts the plaintext data key to an encrypted data key with the user's master key. The key server will then send both the plaintext data kay and the encrypted data key to the system 100. The system 100 encrypts the user's data with the plaintext data key, stores encrypted user's data and the encrypted data key, and deletes the plaintext data key.

When the system 100 need to encrypt the user's data when, for example, the user requests to view or edit data, the system 100 sends the encrypted data key to the key server. The key server decrypts the encrypted data key into plaintext data key using the user's master key. The key server then sends the plaintext data key to system 100, which will then be used to decrypt the user's data. After the user's session has ended, the system 100 will delete the plaintext data key.

All the data transmission among the key server, the system 100, and the user are encrypted using web transport protocol such as HTTPS.

In this example, the encryption may be symmetrical or asymmetric. After the user stores a master key on the key server, the master key will then never be transmitted only. A data key will be generated and transmitted to encrypt the user's data. The encryption and decryption of the user's data is performed by the system 100, however, the system 100 does not store a plaintext copy of the data key but only an encrypted cop of the data key. The encryption and decryption of the data key is performed by the key server using the user's master key. Therefore, the security of the user's data is improved.

While the foregoing specification has been described with regard to certain preferred embodiments, and many details have been set forth for the purpose of illustration, it will be apparent to those skilled in the art without departing from the spirit and scope of the invention, that the invention may be subject to various modifications and additional embodiments, and that certain of the details described herein can be varied considerably without departing from the basic principles of the invention.

What is claimed:

1. A method, implemented on a computing system having at least one processor, memory coupled to the at least one processor, storage, and a communication device connected to a network, for generating and distributing a web form for collecting data, comprising:
providing a graphical interface to a user, wherein the user specify at least one data field and data type of the data field of a web form;
generating the web form comprising the at least one data field;
storing the web form;
making accessible of the web form to one or more recipients;
receiving one or more responses of the web form from the one or more recipients;
associating of each of the one or more recipients to the one or more responses;
encrypting the stored web form and the received responses, wherein the stored web form and the received responses are only available to the user.

2. The method of claim 1, further comprising:
providing the user a pair of public key and private key in which a message encrypted using the public key can only be decrypted with the private key, wherein the stored web form and the received responses are encrypted using the public key.

3. The method of claim 1, further comprising:
store a master key corresponding to the user at a key server; and
wherein encrypting the stored web form and the received responses comprises:
obtaining a plaintext data key and an encrypted data key which is obtained by encrypting the plaintext data key using the master key from the key server;
encrypting the stored web form and the received responses using the plaintext data key; and
deleting the plaintext data key;
storing the encrypted data key.

4. The method of claim 3, further comprising:
providing the encrypted data key to the key server;
obtaining the plaintext data key decrypted using the master key from the key server;
decrypting the stored web form and the received responses using the plaintext data key; and
deleting the plaintext data.

5. The method of claim 1, further comprising:
upon the user's request, exporting the one or more responses to a document or database on the user's device or on an online platform.

6. The method of claim 1, wherein providing one or more recipients accessibility of the web form further comprises:
upon the user's choice, providing the one or more recipients a URL of the web form through at least one of email, SMS text, and social media post.

7. The method of claim 6, wherein the URL is presented in plain text or QR code.

8. The method of claim 1, further comprising:
providing the user a content of each web form that is being partially filled by the one or more recipients.

9. The method of claim 1, further comprising:
providing the user a statistic of status of the web form provided to each of the one or more recipients.

10. The method of claim 1, wherein providing a graphical interface to a user further comprises:
providing an element library for the user to choose for the data field which comprises at least one of single input, multiple input, check box, radio group choice, dropdown, rating, ranking, image, Boolean, signature pad, file uploader; and
wherein the graphic interface allows the user to set a logic rule to change the web form in response to a recipient's input to a data field.

11. The method of claim 10, wherein the interface further provides validation of the data filed.

12. A system for designing and distributing a web form for collecting data, comprising at least one processor, memory coupled to the at least one processor, and communication device connected to a network, the memory comprising computer executable instructions that, when executed by the at least one processor, performs a method comprising:
providing a graphical interface to a user, wherein the user specify at least one data field and data type of the data field of a web form;
generating the web form comprising the at least one data field;
storing the web form;
making accessible of the web form to one or more recipients;
receiving one or more responses of the web form from the one or more recipients;
associating of each of the one or more recipients to the one or more responses;
encrypting the stored web form and the received responses, wherein the stored web form and the received responses are only available to the user.

13. The system of claim 12, wherein the method further comprises:
providing the user a pair of public key and private key in which a message encrypted using the public key can only be decrypted with the private key, wherein the stored web form and the received responses are encrypted using the public key.

14. The system of claim 12, wherein the method further comprises:
store a master key corresponding to the user at a key server; and
wherein encrypting the stored web form and the received responses comprises:
obtaining a plaintext data key and an encrypted data key which is obtained by encrypting the plaintext data key using the master key from the key server;
encrypting the stored web form and the received responses using the plaintext data key; and
deleting the plaintext data key;
storing the encrypted data key.

15. The system of claim 14, wherein the method further comprises:
providing the encrypted data key to the key server;
obtaining the plaintext data key decrypted using the master key from the key server;
decrypting the stored web form and the received responses using the plaintext data key; and
deleting the plaintext data.

16. The system of claim 12, wherein the method further comprises:
upon the user's request, exporting the one or more responses to a document or database on the user's device or on an online platform.

17. The system of claim 12, wherein providing one or more recipients accessibility of the web form further comprises:
upon the user's choice, providing the one or more recipients a URL of the web form through at least one of email, SMS text, and social media post.

18. The system of claim 17, wherein the URL is presented in plain text or QR code.

19. The system of claim 12, wherein the method further comprises:
providing the user a content of each web form that is being partially filled by the one or more recipients.

20. The system of claim 12, wherein the method further comprises:
providing the user a statistic of status of the web form provided to each of the one or more recipients.

21. The system of claim 12, wherein providing a graphical interface to a user further comprises:
providing an element library for the user to choose for the data field which comprises at least one of single input, multiple input, check box, radio group choice, dropdown, rating, ranking, image, Boolean, signature pad, file uploader; and
wherein the graphic interface allows the user to set a logic condition to decide if an element is visible, or require, or editable.

22. The system of claim 21, wherein the interface further provide validation of the data filed.
